(19) United States
(12) Patent Application Publication
(10) Pub. No.: US 2015/0336546 A1
(43) Pub. Date: Nov. 26, 2015

(54) METHOD AND SYSTEM FOR VEHICLE TO SENSE ROADBLOCK

(71) Applicant: UMM AL-QURA UNIVERSITY, Makkah (SA)

(72) Inventor: Fahad Mohammed AL-ZAHRANI, Makkah City (SA)

(73) Assignee: UMM AL-QURA UNIVERSITY, Makkah (SA)

(21) Appl. No.: 14/362,283

(22) PCT Filed: May 19, 2014
(86) PCT No.: PCT/IB2014/000763

§ 371 Date: Jun. 2, 2014

(51) Int. Cl. B60T 7/12; G01S 17/93; G01S 17/08

(52) U.S. Cl. CPC B60T 7/12; G01S 17/08; G01S 17/936

(57) ABSTRACT

A system and a method detect a presence of a roadblock and perform an evaluation of a vehicle's approach to a roadblock located at a flat road surface, or an upslope road surface or a downslope road surface. A roadblock sensor system includes a transmitter, a receiver and processing circuitry. The processing circuitry includes a road surface slope information detector, a roadblock information detector, a road surface and roadblock information calculator, a decision processor, a vehicle speed controller, a vehicle navigation controller and an impact reduction controller.

### TECHNICAL FIELD

The present disclosure relates to a method and a system for detecting the information of the roadblocks, such as, bumps, deep drilling and roadwork at a flat, upslope or downslope road surface, sending a signal to the system of the vehicle, giving a warning signal to the driver, and then reducing the speed automatically or detour.

### BACKGROUND

Road surface anomalies, such as potholes, road bumps, railroad crossing, joints, can determine some problems for vehicles and further affect road users' safety. For example, a road may have a low quality road surface due to the presence of one or more of holes in the road surface, often known as “pot-holes”, bumps or undulations in the road surface which reduce the speed at which a vehicle may safely travel the road.

Possible obstacles for a vehicle also include speed bumps built into the road intentionally to force the driver to reduce driving speed. Such road bumps, may be designed as half sinusoidal-shape waves or bumps, but also having front and back ramps and different heights. They force the driver to drive over them at a reduced speed to minimize vibrations of the vehicle and the occupants and avoid damage to the vehicle, in particular to the shock absorbers. Normally, such road bumps are used on streets where children are at play, in residential areas or, at points of entry into towns or community center to prevent high-speed driving in the area of the road bump and remind the driver that he must check and possibly adjust his speed also in the following area.

It is possible that the driver fails to notice a road bump, in particular in complex driving situations. Especially when trying to find his way in strange cities and due to general distraction sources such as fellow passengers, or when tires, there is the danger that a road bump is not noticed in a timely manner or at all and the driver drives over it at an excessive speed. Also, at night or under poor visibility conditions, there is an increased risk that a road bump is not recognized by the driver, especially if color markings such as white zig-zag lines fade over time and are unable to adequately fulfill their desired warning function.

In addition to the strong vibrations caused thereby to the vehicle and the passengers, chassis components may also be damaged. More importantly, the service life of the shock absorbers is considerably reduced. Since, if the vehicle is driven over a road bump at an unadjusted speed, it partially loses contact with the ground, the braking distance of an initiated or ongoing braking maneuver becomes longer. In the worst case, as recognized by the present inventor, the vehicle may become fully uncontrollable.

While the route determination process therefore implicitly takes into account road surface quality and its impact on average speed for a road, it is desired to allow an improvement of the route planning process by allowing road surface quality to be taken into account. For example, for some cars, such as sports-cars with limited suspension travel or hard suspension, a user may wish to plan a route which only follows roads having a relatively good quality road surface, thereby avoiding, as far as possible, roads having pot-holes, bumps and road-surface traffic calming measures.

It is desired as recognized by the present inventor that road surface conditions during vehicular travel be estimated with accuracy and the estimation be fed back to vehicular control to improve the running safety of vehicles. If road surface conditions can be estimated during vehicular travel, a more advanced control of ABS (antilock braking system) braking, for instance, can be realized before such danger avoidance action as braking, acceleration, or steering is taken. Also, a more advanced navigation device that detects manholes, speed bumps, etc. based on a detector sensor, which can improve the driver experience to allow an improvement in route determination by taking into account road-surface quality information, particularly by automatically collecting information on road-surface feature types.

Previously, electromagnetic wave radar was used for measuring the direction and distance from the vehicle to the roadblock. However, since the breadth angle of the beam from an electromagnetic wave emits towards a target is wide, the direction or distance of a roadblock may not be measured at sufficient precision to judge the whether or not the vehicle can pass the roadblock. The technique of using a laser radar in which a measurement higher-precision than an electromagnetic wave radar is possible is proposed for the purpose of solving this problem. Specifically, a laser beam is irradiated to road surface upper direction (front upper direction of a vehicle) from an emission point, By scanning to two-dimensions, the distance to the lower end of the target which exists in a road surface upper direction, and an angle are measured, the height of the lower end of a target is compared with the top height of a vehicle from the measurement result.

### SUMMARY

Among other things, the devices and methods disclosed herein can be used to detect overhead obstacles as the vehicle approaches them, and can signal the driver to stop when the approach speed is fast enough or close enough to result in an impact or collision.

The present disclosure provides a roadblock sensor, a collision preventing device, and a roadblock obstacle sensing method which are capable of obtaining the height, width and depth information from a roadblock existing above a road surface to the road surface regardless of changes in state of a road slope and in posture of a vehicle

A roadblock sensor system for detecting the presence of and evaluation the approach to a roadblock located at a flat road surface, or an upslope road surface or a downslope road surface in the path of a vehicle includes: a transmitter emitting a laser light signal that can detect the roadblock and the flat road surface, or the upslope surface or the downslope surface in the path of the vehicle; a receiver receiving said laser light reflected from the roadblock and the flat road surface, or the upslope surface or the downslope surface in the path of the vehicle, and a microcontroller using reflected signals to calculate a height and a width of said roadblock located at the road surface and making decisions based on the height and the width information. The microcontroller includes: a road surface slope information detector to detect the flat surface, or the upslope surface or the downslope surface information, a roadblock information detector to detect the roadblock at the flat surface, or the upslope surface or the downslope surface, a road surface and roadblock information calculator to calculate the height and the width of the roadblock at the flat surface, or the upslope surface or the downslope surface, a decision processor to determinate whether or not the vehicle can pass the roadblock at the flat surface, the upslope surface or the downslope surface, a vehicle speed controller to control the vehicle′ speed, a vehicle navigation controller to control the vehicle's route, an impact reduction controller to send a warning signal and directing the vehicle speed controller and the vehicle navigation controller.

In the first feature, the vehicle speed controller decelerates the vehicle by operating a brake of said vehicle automatically to pass the roadblock.

In the first feature, a vehicle navigator controller detour the vehicle when the decision processor determines vehicle cannot pass the roadblock.

A method for a vehicle on a road surface to sense an roadblock on the road surface includes: detecting road surface information located outside the vehicle through a sensor and a road surface slope information detector; ascertaining whether a upslope or downslope exists through a decision processor; detecting, multiple-angle information of the roadblock's dimension and the road slope information; calculating, a height and a width of the roadblock based on the multiple-angle information of the roadblock's dimension and the road slope information if the upslope or the downslope exists; deciding whether the vehicle can pass the roadblock based on the height, the width of the roadblock through the decision processor; sending a warning signal through an impact reduction controller; reducing the vehicle's speed through a vehicle speed controller; or detouring the vehicle through a vehicle navigation controller.

In the second feature, the vehicle speed controller decelerates the vehicle by operating a brake of the vehicle automatically to pass the roadblock

In the second feature, the vehicle navigator controller detour the vehicle when the decision processor determines vehicle cannot pass the roadblock

### BRIEF DESCRIPTION OF THE DRAWING

FIG. 1 is a block diagram of a roadblock sensing system.

FIG. 2 is a flow chart of a decision method view in the roadblock sensing system of FIG. 1.

FIG. 3 (a) is a diagram of a slope geometry of a flat road surface, FIG. 3 (b) is a diagram of the slope geometry of an upslope road surface and FIG. 3 (c) is a diagram of the slope geometry of a downslope road surface.

FIG. 4 (a) is a schematic diagram of a scan geometry at the flat road surface, by the system of FIG. 1, and FIG. 4 (b) is a schematic diagram of another scan geometry at the flat road surface, by the system of FIG. 1.

FIG. 5 (a) is a schematic diagram of a scan geometry at the upslope road surface, by the system of FIG. 1, and FIG. 5 (b) is a schematic diagram of another scan geometry at the upslope road surface, by the system of FIG. 1.

FIG. 6 (a) is a schematic diagram of a scan geometry at the downslope road surface, by the system of FIG. 1, and FIG. 6 (b) is a schematic diagram of another scan geometry at the downslope road surface, by the system of FIG. 1.

FIG. 7 is a diagrammatic overview of a system for implementing the method of roadblock sensing system according to the present disclosure.

### DETAILED DESCRIPTION

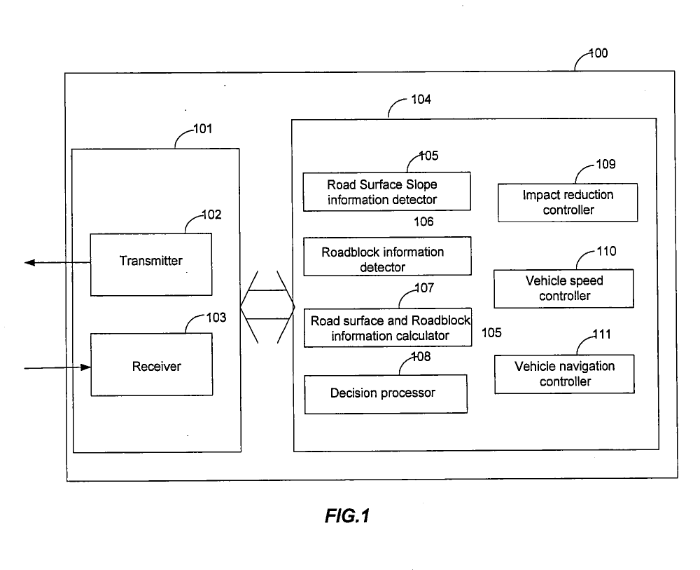

An exemplary roadblock sensing system will now be described with respect to FIGS. 1-7.

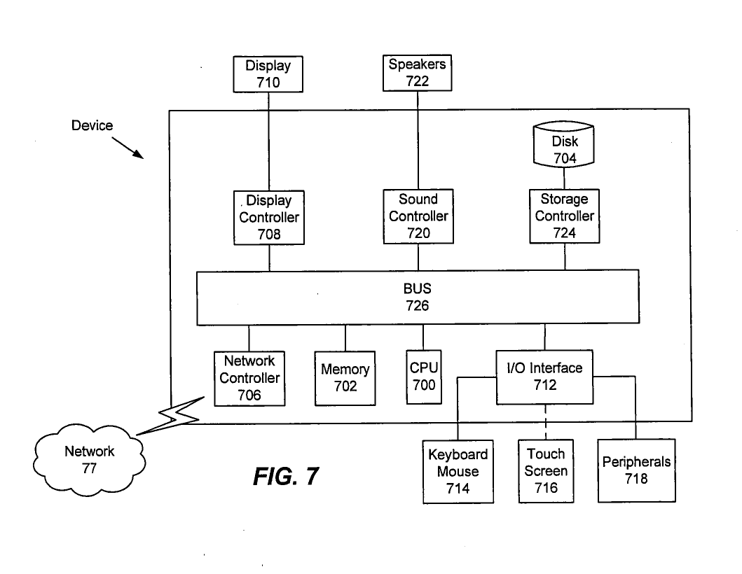

FIG. 1 is a block diagram of an example roadblock sensing system 100. It includes a sensor 101 and a microcontroller 104. The sensor 101 includes a transmitter 102 that emits a laser beam, and a receiver 103 that detects a reflected portion of the laser beam. The microcontroller 104 includes a road surface slope information detector 105, a roadblock information detector 106, a roadblock information calculator 107, a decision processor 108, an impact reduction controller 109, a vehicle speed controller 110 and a vehicle navigation controller 111, as will be discussed. The different detectors and calculators use processing circuitry (see FIG. 7) to provide assessment and decision making determinations for the system.

The road surface slope information detector 105 detects road surface conditions, such as slope as will be discussed. The roadblock information detector 106 detects distance between a “roadblock” and the vehicle, as well as the multiple-angle information of the roadblock's height and width. The roadblock information calculator 107 calculates the distance between the roadblock and the vehicle, the road surface slope angle, and the roadblock's height and width based on input from the road surface slope information detector 105 and the roadblock information detector 106. The decision processor 108 determines the existence of the road slope on the road surface and whether the vehicle can pass the roadblock. The impact reduction controller 109 generates a warning signal when the decision processor 108 determines the roadblock is a significant obstacle based on the road and vehicle conditions. The vehicle speed controller 110 controls the speed of a vehicle and the vehicle navigation controller 111 detours (follows an avoidance route) the vehicle if the decision processor 108 determines the vehicle cannot reliably pass the roadblock.

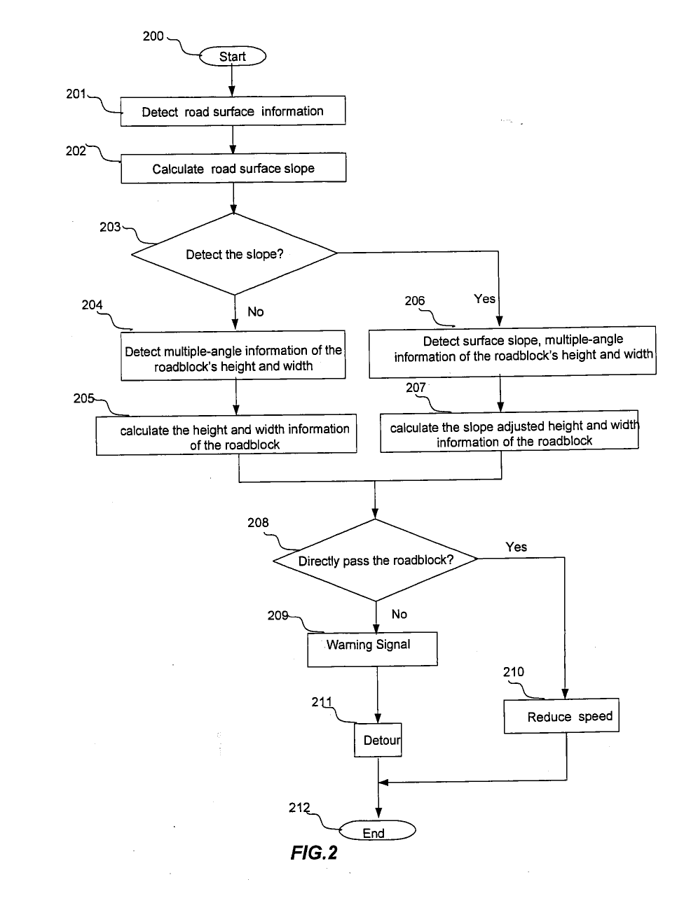

FIG. 2 is a flow chart explaining the decision method of the roadblock sensing system 100 of FIG. 1. Upon startup at 200, the road sensor system 100 is switched on or power is applied thereto, so the system executes the detection of the road surface information in step 201. At step 202, the road surface and roadblock information calculator 107 calculates the detected information of road surface detected at step 201. At step 203, the decision processor 108 determines whether the road surface has a slope above a predetermined amount based on the information obtained from step 201 and 202. For the flat surface, the height and width information of the roadblock are detected by the roadblock information detector 106 and height and width dimensions are calculated by the road surface and roadblock information calculator 107 from step 204 to step 205. For an upslope road surface and a downslope surface, the road surface's slope information is detected by road surface slope information detector 105 and the height and width information about the roadblock is detected by roadblock information detector 106 at step 206. A slope-adjusted height and width information of the roadblock is calculated by the road surface and roadblock information calculator 107 at step 207. At step 208, the decision processor 108 determines whether the vehicle can directly pass the roadblock. If the decision processor 108 determines that the vehicle cannot directly pass the roadblock, the impact reduction controller 109 sends a warning signal at step 209 and directs the vehicle navigation controller 111 to detour at step 211. If the decision processor 108 determines that the vehicle can directly pass the roadblock, the impact reduction controller 109 directs the vehicle speed controller 110 to reduce the vehicle speed at step 210.

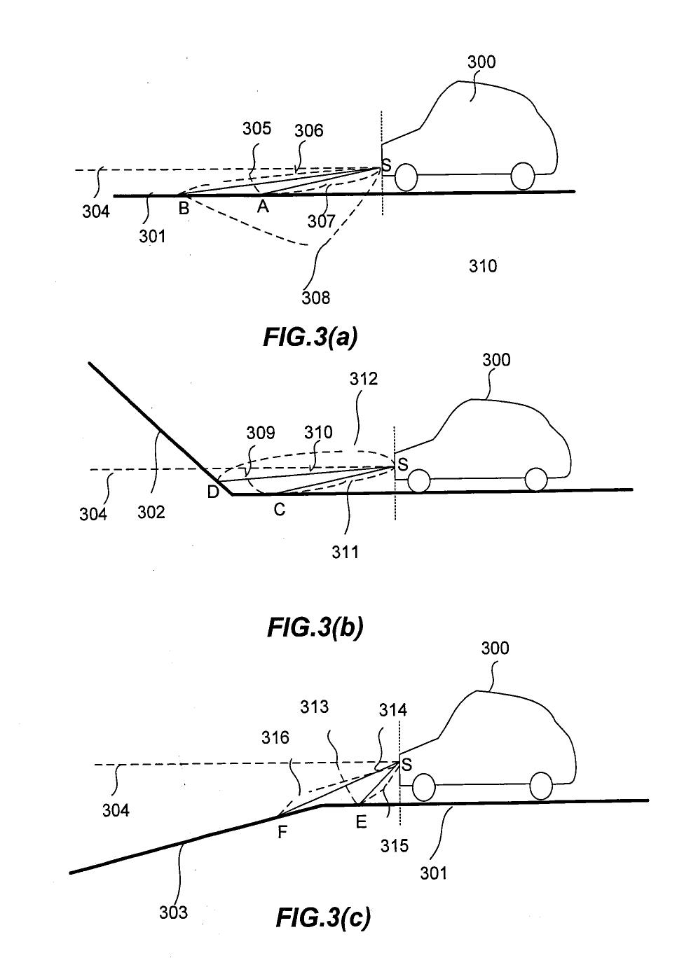

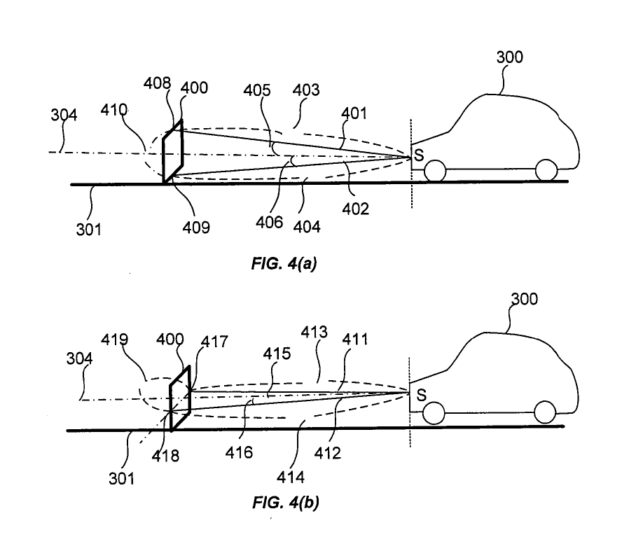

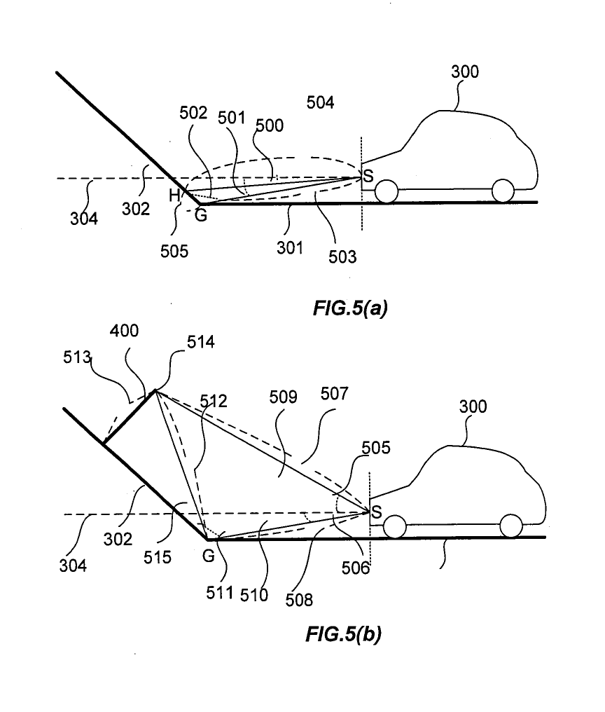

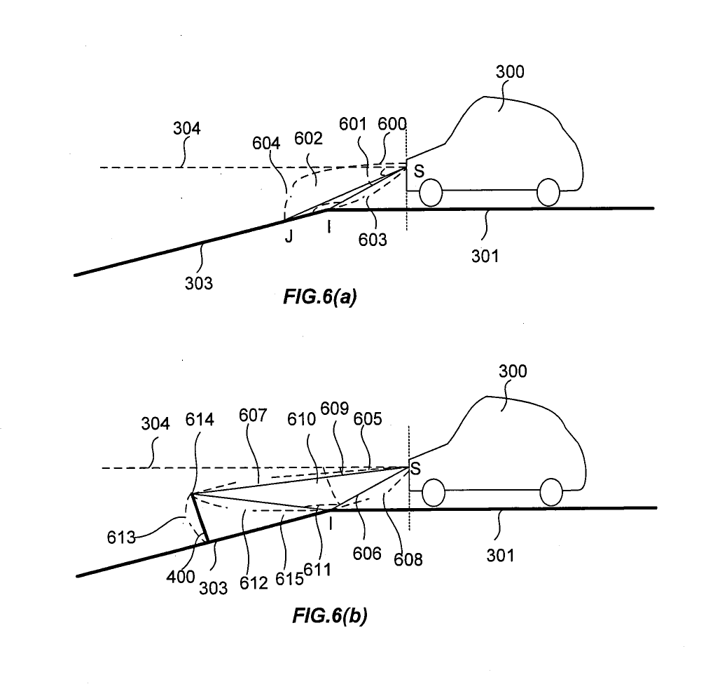

As will be discussed, FIG. 3 (a) is a diagram for explaining the calculation of the slope at a flat road surface, FIG. 3 (b) is a diagram for explaining the calculation of the slope at an upslope road surface and FIG. 3 (c) is a diagram for explaining the calculation of the slope at an downslope road surface. FIG. 4 (a) is a schematic diagram for explaining the scan geometry and calculation of height at a flat road surface, the system of FIG. 1 and FIG. 4 (b) is a schematic diagram for explaining the scan geometry and the calculation of the width of the roadblock at the flat road surface, by the system of FIG. 1. FIG. 5 (a) is a schematic diagram for explaining the scan geometry and calculation of the slope at the upslope road surface, by the system of FIG. 1, and FIG. 5 (b) is a schematic diagram for explaining the scan geometry and calculation of the height of a roadblock at the upslope road surface, by the system of FIG. 1. FIG. 6 (a) is a schematic diagram for explaining the scan geometry and calculation of the slope at the downslope road surface, by the sensor of FIG. 1, and FIG. 6 (b) is a schematic diagram for explaining the scan geometry and calculation of the height of a roadblock at the downslope road surface, by the system of FIG. 1.

At step 201 (FIG. 2), as a vehicle 300 moves on road in a driving direction, in the front area of the vehicle 300 (FIG. 3a) a sensor 101 is used for detecting road surface information in front of the vehicle 300. The transmitter 102 controls the light emission direction of the laser beam.

As shown in FIG. 3 (a), a slope scan of the flat surface 301 is implemented by scanning sample points A and B on the surface 301 through the road surface slope information detector 105. In the present implementation, two sample points are selected. Based on a different application purpose, the number of the sampling points can be arranged from two to infinity. For the sample point A, an angle α_{A} 305 is an angle between a vehicle center axis line CL 304 and a emission direction SA of laser-beam. For the sampling point B, an angle α_{B} 306 is an angle between the vehicle center axis line CL 304 and a emission direction SB of laser-beam.

Based on the emission timing of the laser-beam acquired from the transmitter 102, and the detection timing of laser-beam acquired from the receiver 103, the road surface slope information detector 105 collects the timing and angle data related to the sample points. The sample point A detection time T_{A} is the time that starts from the time the transmitter 102 emits the laser light, the lights reflects at the sample point A, and ends at the time the laser beam is detected by the receiver 103. The sample point B detection time T_{B} is the time that starts from the time the transmitter 102 emits the laser light, the lights reflects at the sampling point B, and ends at the time the laser beam is detected by the receiver 103. The value of the angle α_{A} 305 based on the sample point A that matched with the sample point A detection time T_{A}, is detected by the receiver 103. The value of the angle α_{B} 306 based on the sample point B that matched with the sample point B detection time T_{B}, is detected by the receiver 103.

As shown in FIG. 3 (b), a slope scan of the upslope surface 302 is implemented by scanning sample points C and D on the flat surface 301 and the upslope surface 302 through the road surface slope information detector 105. In the present implementation, two sample points are selected. Based on the different application purpose, the number of the sample points can be arranged from two to infinity. At least one sample point may be selected from the upslope surface 302, such as the sample point D in the present implementation. For the sample point C, an angle α_{C} 309 is an angle between the vehicle center axis line CL 304 and the a emission direction SC. For the sampling point D, an angle α_{D} 310 is an angle between the vehicle center axis line CL 304 and a emission direction SD.

Based on the emission timing of laser-beam acquired from the transmitter 102, and the detection timing of laser-beam acquired from the receiver 103, the road surface slope information detector 105 collects the timing and angle data related to the sample points. The sample point C detection time T_{C} is the time that starts from the time the transmitter 102 emits the laser light, the lights reflects at the sample point C, and ends at the time the laser beam is detected by the receiver 103. The sample point D detection time T_{D} is the time that starts from the time the transmitter 102 emits the laser light, the lights reflects at the sampling point D, and ends at the time the laser beam is detected by the receiver 103.

As shown in FIG. 3 (c), a slope scan of the downslope case is implemented by scanning sample points E and F on the flat surface 301 and the downslope surface 303 through the road surface slope information detector 105. In the present implementation, two sample points are selected. Based on the different application purpose, the number of the sample points can be arranged from two to infinity. At least one sample point may be selected from the downslope surface 303, such as the sample point F in the present implementation. For the sample point E, an angle α_{E} 313 is an angle between the vehicle center axis line CL 304 and a emission direction SE. For the sampling point F, an angle α_{F} 314 is an angle between the vehicle center axis line CL 304 and a emission direction SF.

Based on the emission timing of laser-beam acquired from the transmitter 102, and the detection timing of laser-beam acquired from the receiver 103, the road surface slope information detector 105 collects the timing and angle data related to the sample points. The sample point E detection time T_{E} is the time that starts from the time the transmitter 102 emits the laser light, the lights reflects at the sample point E, and ends at the time the laser beam is detected by the receiver 103. The sample point F detection time T_{F} is the time that starts from the time the transmitter 102 emits the laser light, the lights reflects at the sampling point F, and ends at the time the laser beam is detected by the receiver 103.

At step 202, the road surface slope information is calculated by the roadblock surface and roadblock calculator 107.

In FIG. 3(a), the sample point A detection time T_{A} and a distance D_{SA} 307 from the sensor 101 to the flat road surface 301 based on a speed of the laser beam S_{L} is calculated from D_{SA}=(S_{L}*T_{A})/2. The sample point B detection time T_{B} and a distance D_{SB} 308 from the sensor 101 to the road surface 301 based on the speed of the laser beam S_{L} is calculated from D_{SB}=(S_{L}*T_{B})/2. Equation (1) is the criteria for the decision processor 108 to determine the flat road surface for at step 203.

In FIG. 3(b), the sample point C detection time T_{C} and a distance D_{SC} 311 from the sensor 101 to the flat road surface 301 based on the speed of the laser beam S_{L} are calculated from D_{SC}=(S_{L}*T_{C})/2. The sample point B detection time T_{B} and a distance D_{SD} 312 from the sensor 101 to the upslope road surface 302 based on the speed of the laser beam S_{L} are calculated from D_{SD}=(S_{L}*T_{D})/2. Equation (2) is the criteria for the decision processor 108 to determine the upslope road surface for at step 203.

In FIG. 3(c), the sample point E detection time T_{E} and a distance D_{SE} 313 from the sensor 101 to the flat road surface 301 based on the speed of the laser beam S_{L} are calculated from D_{SE}=(S_{L}*T_{E})/2. The sample point B detection time T_{B} and a distance D_{SD} 314 from the sensor 101 to the downslope road surface 303 based on the speed of the laser beam S_{L} are calculated from D_{SF}=(S_{L}*T_{F})/2. Equation (3) is the criteria for the decision processor 108 to determine a downslope road surface for at step 203.

D_{SA}*sin(α_{A})=D_{SB}×sin(α_{B}) (1)

D_{SC}*sin(α_{C})>D_{SD}×sin(α_{D}) (2)

D_{SE}*sin(α_{E})<D_{SF}×sin(α_{F}) (3)

Where the angle α_{A} 305 is an angle between the vehicle center axis line CL 304 and the emission direction SA, the angle α_{B} 306 is an angle between the vehicle center axis line CL 304 and the emission direction SB, the angle α_{C} 309 is an angle between the vehicle center axis line CL 304 and the emission direction SC, the angle α_{D} 310 is an angle between the vehicle center axis line CL 304 and the emission direction SD, the angle α_{E} 313 is an angle between the vehicle center axis line CL 304 and the emission direction SE, the angle α_{F} 314 is an angle between the vehicle center axis line CL 304 and the emission direction SF.

For the flat surface, the height and width information about the roadblock are detected by the roadblock information detector 106 at step 204.

As shown in FIG. 4 (a), a height scan of the roadblock 400 is implemented by changing an angle α_{U} 405 of a laser beam L_{U} 401 and an angle α_{D} 406 of a laser beam L_{D} 402 and specifically repeating the scan of a vertical and a horizontal direction of the roadblock 400 to locate a highest point H_{U} 408 and a lowest point H_{D} 409 of the roadblock 400. In this case, the lowest point H_{D} 409 of the roadblock 400 is also the road surface 301.

The angle α_{U} 405 is an angle of the up-down direction to a emission direction of the laser-beam L_{U} 401 which scans the highest point H_{U} 408 of the roadblock 400 from the vehicle central axis line CL 304. The angle α_{D} 406 is an angle of the up-down direction to the emission direction of the laser-beam L_{D} 402 which scans the lowest point H_{D} 409 of the roadblock 400 from the vehicle center axis line CL 304. And the transmitter 102 emits the laser-beam L_{U} 401 by the angle α_{U} 405 for the scans the highest point H_{U} 408 of the roadblock 301. Subsequently, the transmitter 102 scans the laser-beam L_{D} 402 by the angle α_{D} 406 for the lowest point H_{D} 409 of the roadblock 400 at the vertical and horizontal direction of the roadblock 400.

As shown in FIG. 4 (b), a width scan of the roadblock is implemented by changing a clockwise angle α_{R} 415 and a counter-clockwise angle α_{L} 416 and specifically repeating the scan at the vertical and horizontal direction of the roadblock 400 to locate a rightmost point W_{R} 417 and a leftmost point W_{L} 418 of the roadblock 400.

The clockwise angle α_{R} 415 is an angle of the clockwise direction to the emission direction of a laser-beam L_{R} 411 which scans the roadblock 400 from the vehicle center axis line CL 304. The counter-clockwise angle α_{L} 416 is an angle of the counter-clockwise direction to the emission direction of a laser-beam L_{L} 412 which scans the roadblock from the vehicle center axis line CL 304. And the transmitter 102 scans the laser-beams L_{R} 411 by the angle-of-clockwise α_{R} 415 for the rightmost point W_{R} 417 of the roadblock 400. Subsequently, the transmitter 102 scans the laser-beam L_{L} 412 by the angle-of-counter-clockwise α_{L} 416 for the leftmost side W_{L} 418 of the roadblock 400.

Moreover, while the transmitter 102 outputs the timing which emits the laser beam L_{U} 401, L_{D} 402, L_{L} 411 and L_{R} 412 with respect to the roadblock information detector 106. The value of the angle α_{U} 405 of the laser-beam L_{U} 401, the angle α_{D} 406 of the laser-beam L_{D} 402, the angel α_{R} 415 of the laser-beam L_{R} 411 and the angle α_{L} 416 of the laser-beam L_{L} 412, and are outputs.

The receiver 103 detects the laser beam which emitted from the transmitter 102 and reflected from the roadblock 400. Furthermore, the receiver part 102 outputs the timing which detected the laser beam to the Roadblock information detector 106.

Based on the emission timing of laser-beam L_{U} 401 acquired from the transmitter 102, and the detection timing of laser-beam L_{U} 401 acquired from the receiver 103, the roadblock information detector 106 detects the timing information. A 1st time T1 starts from the time laser beam L_{U} 401 is emitted by the transmitter 102, and ends at time the laser beam reflects from the roadblock 400 and is detected by the receiver part 103. Moreover, when the roadblock information detector 106 acquires the detection timing of laser beam L_{U} 401 from the receiver 103 (namely, when the 1st time T1 is able to be measured), the value of the elevation angle α_{U} 405 matched with the 1st time T1 is detected by the receiver 103.

Based on the emission timing of laser-beam L_{D} 402 acquired from the transmitter 102, and the detection timing of laser-beam L_{D} 402 acquired from the receiver 103, the roadblock information detector 106 detects a timing information. A 2nd time T2 starts from the time the laser beam L_{D} 402 is emitted by the transmitter 102, and ends at the time the laser beam reflects from the roadblock 400 and is detected by the receiver part 103. Moreover, when the roadblock information detector 106 acquires the detection timing of laser beam L_{D} 402 from the receiver 103 (namely, when the 2nd time T2 is able to be measured), the value of the angle α_{D} 406 matched with the 2nd time T2 is also detected.

Based on the emission timing of laser-beam L_{R} 411 acquired from the transmitter 102, and the detection timing of laser-beam L_{R} 411 acquired from the receiver 103, the roadblock information detector 106 detects the timing information. A 3rd time T3 starts from the time the laser beam L_{R} 411 is emitted by the transmitter 102, and ends at the time the laser beam reflects from the roadblock 400 and is detected by the receiver part 103. Moreover, when the roadblock information detector 106 acquires the detection timing of laser beam L_{R} 411 from the receiver 103 (namely, when the 3rd time T3 is able to be measured), the value of the clockwise angle α_{R} 415 matched with the 3rd time T3 is also detected.

Based on the emission timing of laser-beam L_{L} 412 acquired from the transmitter 102, and the detection timing of laser-beam L_{L} 412 acquired from the receiver 103, the roadblock information detector 106 detects the timing information. A 4th time T4 starts from the time laser beam L_{R} 412 is emitted by the transmitter 102, and ends at the time the laser beam reflects from the roadblock 400 and is detected by the receiver part 103. Moreover, when the roadblock information detector 106 acquires the detection timing of laser beam L_{L} 412 from the receiver 103 (namely, when the 4th time T4 is able to be measured), the value of the counter-clockwise angle α_{L} 416 concerning laser-beam L_{L} 412 matched with the 4th time T4 is detected.

At step 205, the roadblock to the vehicle's distance R_{D} and the height R_{H} 410 and width R_{W} 419 of the roadblock 400 at the flat surface 301 are calculated. The road surface and roadblock information calculator 107 calculates roadblock height R_{H} 410 and width R_{W} 419.

That is, calculating the roadblock height R_{H} is based on the 1st time T1, the angle α_{U} 405, the 2nd time T2 and the angle α_{D} 406. Based on the 3rd time T3 and the α_{R} 415, the 4th time T4 and the α_{L} 416, the roadblock width R_{W} 419 is calculated.

In FIG. 4 (a), the road surface and roadblock information calculator 107 calculates a 1st distance D_{U} 403 from the sensor 100 to the highest point H_{U} of roadblock 400 based on the speed of the laser beam S_{L} from D_{U}=(S_{L}*T₁)/2. A 2nd distance D_{D} 404 from the sensor 100 to the lowest point H_{D} 409 of the roadblock is calculated based on the speed of the laser beam S_{L} from D_{D}=(S_{L}*T₂)/2. In FIG. 4(b), a 3rd distance D_{R} 413 from the sensor 100 to the rightmost point W_{R} 417 of the roadblock is calculated based on the speed of the laser beam S_{L} from D_{R}=(S_{L}*T₃)/2. A 4th distance D_{L} 414 from the sensor 100 to the rightmost point W_{L} 418 of the roadblock is calculated based on the speed of the laser beam S_{L} from D_{L}=(S_{L}*T₄)/2. The distance between the sensor and the roadblock may be calculated based on Equation (4). The roadblock height R_{H} based on Formula (5) while calculating roadblock width R_{w} based on the formula equation (6).

R_{D}=R_{U}×cos(α_{U}) (4)

R_{H}={D_{U}×sin(α_{U})+D_{D}×sin(α_{D})} (5)

R_{W}={D_{L}×sin(α_{L})+D_{R}×sin(α_{R})} (6)

For the upslope and downslope surfaces, the road surface slope information is detected by the road surface slope information detector 105 and the height and width information about the roadblock 400 is detected by the roadblock information detector 106 at step 206.

As shown in FIG. 5 (a), a slope scan of the upslope angle condition is implemented by scanning sample points H and G on the flat surface 301 and the upslope surface 302 through the road surface slope information detector 105. In the present implementation, the sample point G is selected at the intersection of the flat surface 301 and the upslope surface 302, and the sample point H is selected on the upslope surface 302. For the sample point G, an angle-of-slope α_{G} 501 is an angle between the vehicle center axis line CL 304 and a emission direction SG of the laser-beam. For the sampling point H, an angle-of-slope α_{H} 500 is an angle between the vehicle center axis line CL 304 and a emission direction SH.

Based on the emission timing of the laser-beam acquired from the transmitter 102, and the detection timing of the laser-beam acquired from the receiver 103, the road surface slope information detector 105 collects timing and angle data related to the sample points. A sample point H detection time T_{H} is the time that starts from the time the transmitter 102 emits the laser light, the lights reflects at the sample point H, and ends at the time the laser beam is detected by the receiver 103. A sample point G detection time T_{G} is the time that starts from the time the transmitter 102 emits the laser light, the lights reflects at the sampling point G, and ends at time the laser beam is detected by the receiver 103.

A sample point G detection time T_{G} and a distance D_{SG} 503 from the sensor 101 to the sample point G is calculated based on the speed of the laser beam S_{L} from D_{SG}=(S_{L}*T_{G})/2. A sample point H detection time T_{H} and a distance D_{SH} 504 from the sensor 101 to the sample point H is calculated based on the speed of the laser beam S_{L} from D_{SH}=(S_{L}*T_{H})/2. Equations (7) and (8) are used to calculate the upslope angle information for the condition that the sampling point H is below the vehicle center axis line CL 304. In the case that sampling point H is beyond the vehicle center axis line CL 304, Equation (9) and (10) is used to calculate the upslope angle information.

$$\begin{matrix}{D}_{HG} = {\{ {D}_{SH}^{2} + {D}_{SG}^{2} - 2 \times {D}_{SH} \times {D}_{SG} \times cos ( {α}_{G} - {α}_{H} ) \}}^{0.5} & ( 7 ) \\ {α}_{1} = {sin}^{- 1} \{ \frac{{D}_{SH} \times sin ( {α}_{G} - {α}_{H} )}{{D}_{HG}} \} & ( 8 ) \\ {D}_{HG} = {\{ {D}_{SH}^{2} + {D}_{SG}^{2} - 2 \times {D}_{SH} \times {D}_{SG} \times cos ( {α}_{G} + {α}_{H} ) \}}^{0.5} & ( 9 ) \\ {α}_{1} = {sin}^{- 1} \{ \frac{{D}_{SH} \times sin ( {α}_{G} + {α}_{H} )}{{D}_{HG}} \} & ( 10 )\end{matrix}$$

Where α₁ 501 is the angle ∠ HGS and D_{HG} is the distance between the sample points H and G.

As shown in FIG. 5 (b), a height scan of the roadblock 400 located at a upslope surface 302 is implemented by changing a slope angle U_{U} 509 of a laser beam LU_{U} 505 and a slope angle U_{D} 510 of a laser beam LU_{D} 506 specifically repeating the scan at the vertical and horizontal direction of the roadblock 400 to locate a highest point HU_{U} 514 and an intersection point G of the flat surface 301 and the upslope surface 302.

The U_{U} 509 is a slope angle between the vehicle center axis line CL 304 and the emission direction of laser-beam LU_{U} 505 which scans the highest point HU_{U} 514 of the roadblock 400 from the vehicle central axis line CL 304. The U_{D} 510 is an angle between the vehicle center axis line CL 304 and the emission direction of laser-beam LU_{D} 506 which scans the intersection point G of the flat surface 301 and the upslope surface 302. The transmitter 102 emits the laser-beam LU_{U} 505 by U_{U} 509 to scan the highest point HU_{U} 514 of the roadblock 400. Subsequently, the transmitter 102 scans laser-beams LU_{D} 506 by U_{D} 510 to scan the intersection point G of the flat surface 301 and the upslope surface 302.

Moreover, while the transmitter 102 outputs the timing which emits the laser beam LU_{U} 505 and LU_{D} 506 with respect to the roadblock information detector 106. The value of U_{U} 509 of the laser-beam LU_{U} 505 and the U_{D} 510 of the laser-beam LU_{D} 506, are outputs.

The receiver 103 detects the laser beam which emitted from the transmitter 102 and reflected from the roadblock 400 and road surface. Furthermore, the receiver part 102 outputs the timing which detected the laser beam to the road surface slope information detector 105 and roadblock information detector 106.

The 5th time T5 starts from the time the laser beam LU_{U} 505 is emitted by the transmitter 102, and ends at the time the laser beam reflects from the roadblock 400 and is detected by the receiver 103. Moreover, when the roadblock information detector 106 acquires the detection timing of laser beam LU_{U} 505 from the receiver 103 (namely, when the 5th time T5 is able to be measured), the value of the upslope elevation angle U_{U} 509 matched with the 5th time T5 is detected by the receiver 103.

The 6th time T6 starts from the time the laser beam LU_{D} 506 is emitted by the transmitter 102, and ends at the time the laser beam reflects from the roadblock 400 and is detected by the receiver 103. Moreover, when the roadblock information detector 106 acquires the detection timing of laser beam LU_{D} 506 from the receiver 103 (namely, when the 6th time T6 is able to be measured), the value of the upslope depression angle U_{D} 510 matched with the 6th time T6 is detected by the receiver 103.

At step 207, the roadblock upslope adjusted height RU_{AH} 513 and width of the roadblock 400 at the upslope surface 302 are calculated. The method of calculating a width RU_{W} of the roadblock at the upslope surface 302 is the same as the method of calculating the width of the roadblock at the flat surface. The road surface and roadblock information calculator 107 calculates roadblock height and width.

That is, calculating the roadblock upslope adjusted height RU_{AH} 513 is based on the 5th time T5, the value of the angle U_{U} 509, the 6th time T6 and the value of the angle U_{D} 510.

In FIG. 5 (b), the road surface and roadblock information calculator 107 calculates a 5th distance DU_{U} 507 from the sensor 100 to the highest point HU_{U} 514 of roadblock 400 on the upslope surface based on DU_{U}=(S_{L}*T₅)/2, where S_{L} is the speed of the laser beam. A 6th distance DU_{D} 508 from the sensor 100 to the intersection point G of the flat surface 301 and the upslope surface 302 is calculated based on DU_{D}=(S_{L}*T₆)/2. A roadblock adjusted height RU_{AH} 515 at the upslope surface 302 can be calculated from equation (11)-(14).

$$\begin{matrix}{DU}_{H} = {\{ {DU}_{U}^{2} + {DU}_{D}^{2} - 2 \times {DU}_{U} \times {DU}_{D} \times cos ( {U}_{U} + {U}_{D} ) \}}^{0.5} & ( 11 ) \\ {α}_{2} = {sin}^{- 1} \{ \frac{{DU}_{U} \times sin ( {U}_{U} + {U}_{D} )}{{DU}_{H}} \} & ( 12 ) \\ {α}_{3} = ( {α}_{1} - {α}_{2} ) & ( 13 ) \\ {RU}_{AH} = {DU}_{H} \times sin ( {α}_{3} ) & ( 14 )\end{matrix}$$

Where DU_{H} is the distance between the highest point HU_{U} of roadblock 400 on the upslope surface to the intersection point G of the flat surface 301 and the upslope surface 302, α₁ 502 is the angle ∠ HGS at FIG. 5(a), α₂ 511 is the angle ∠ (HU_{U}) GS, α₃ 515 is the angle between the upslope surface and intersection point G, and RU_{AH} 513 is the adjusted height of roadblock at the upslope surface 302.

As shown in FIG. 6 (a), a slope scan of the downslope angle condition is implemented by scanning sample points I and J on the flat surface 301 and the downslope surface 303 through the road surface slope information detector 105. In the present implementation, the sample point I is selected at the intersection of the flat surface 301 and the downslope surface 303, and the sample point J is selected on the downslope surface 303. For the sample point J, an angle α_{J} 600 is an angle between the vehicle center axis line CL 304 and the emission direction of laser-beam SJ. For the sampling point I, an angle α₁ 601 is an angle between the vehicle center axis line CL 304 and the emission direction of laser-beam SI.

Based on the emission timing of laser-beam acquired from the transmitter 102, and the detection timing of laser-beam acquired from the receiver 103, the road surface slope information detector 105 collects the timing and angle data related to the sample points. A sample point I detection time T_{I} starts from the time the transmitter 102 emits the laser light, the lights reflects at the sample point I, and ends at the time the laser beam is detected by the receiver 103. A sample point J detection time T_{J} starts from the transmitter 102 emits the laser light, the lights reflects at the sampling point J, and ends at the time the laser beam is detected by the receiver 103.

A sample point I detection time T_{I} and a distance D_{SI} 603 from the sensor 101 to the sample point I based on the speed of the laser beam S_{L} is calculated from D_{SI}=(S_{L}*T_{I})/2. A sample point J detection time T_{J} and a distance D_{SJ} 604 from the sensor 101 to the sample point H based on the speed of the laser beam S_{L} is calculated from D_{SJ}=(S_{L}*T_{J})/2. Equation (15) and (16) is used to calculate the downslope angle information.

$$\begin{matrix}{D}_{IJ} = {\{ {D}_{SI}^{2} + {D}_{SJ}^{2} - 2 \times {D}_{SI} \times {D}_{SJ} \times cos ( {α}_{I} - {α}_{G} ) \}}^{0.5} & ( 15 ) \\ {α}_{4} = {sin}^{- 1} \{ \frac{{D}_{SJ} \times sin ( {α}_{J} - {α}_{I} )}{{D}_{IJ}} \} & ( 16 )\end{matrix}$$

Where α₄ 602 is the angle ∠ JIS and D_{IJ} is the distance between the sample points I and J.

As shown in FIG. 6 (b), a height scan of the roadblock 400 located at the downslope surface 303 is implemented by a changing a slope angle D_{U} 609 of a laser beam LD_{U} 605 and a slope angle D_{D} 610 of a laser beam LD_{D} 606 specifically repeating the scan at the vertical and horizontal direction of the roadblock 400 to locate a highest point HD_{U} 614 and an intersection point I of the flat surface 301 and the downslope surface 303.

The D_{U} 609 is an angle between the vehicle center axis line CL 304 and the emission direction of laser-beam LD_{U} 605 which scans the highest point HD_{U} 614 of the roadblock 400. The D_{D} 610 is an angle between the vehicle center axis line CL 304 and the emission direction of laser-beam LD_{D} 606 which scans the intersection point I of the flat surface 301 and the downslope surface 303. The transmitter 102 emits the laser-beam LD_{U} 605 by D_{U} 609 for scanning the highest point HD_{U} 614 of the roadblock 400. Subsequently, the transmitter 102 scans laser-beams LD_{D} 606 by D_{D} 610 for the intersection point I of the flat surface 301 and the downslope surface 303.

Moreover, while the transmitter 102 outputs the timing which emits the laser beam LD_{U} 605 and LD_{D} 606 with respect to the roadblock information detector 106. The value of D_{U} 609 of the laser-beam DD_{U} 605 and the D_{D} 610 of the laser-beam DU_{D} 606, are outputs.

The receiver 103 detects the laser beam which emitted from the transmitter 102 and reflected from the roadblock 400 and downslope road surface 303. Furthermore, the receiver 103 outputs the timing which detected the laser beam to the road surface slope information detector 105 and roadblock information detector 106.

A 7th time T7 starts from the time the laser beam DU_{U} 605 is emitted by the transmitter 102, and ends at the time the laser beam is reflected from the roadblock 400 and is detected by the receiver 103. Moreover, when the roadblock information detector 106 acquires the detection timing of laser beam DU_{U} 605 from the receiver 103 (namely, when the 7th time T7 is able to be measured), the value of the slope angle D_{U} 609 matched with the 7th time T7 is detected by the receiver 103.

A 8th time T8 starts from the time the laser beam DU_{D} 606 is emitted by the transmitter 102, and ends at the time the laser beam reflects from the roadblock 400 and is detected by the receiver 103. Moreover, when the roadblock information detector 106 acquires the detection timing of laser beam DU_{D} 606 from the receiver 103 (namely, when the 8th time T8 is able to be measured), the value of the downslope depression angle D_{D} 610 matched with the 8th time T8 is detected by the receiver 103.

At step 207, the roadblock downslope adjusted height RD_{AH} 613 and width of the roadblock 400 at the downslope surface 303 are calculated. The method of calculating a width RD_{AW} of the roadblock at the downslope surface 303 is the same as the method of calculating the width of the roadblock at the flat surface. The road surface and roadblock information calculator 107 calculates roadblock height and width.

That is, calculating the roadblock upslope adjusted height RD_{AH} 613 is based on the 7th time T7, the value of the downslope angle D_{U} 609, the 8th time T8, the value of the down slope angle D_{D} 610.

In FIG. 6 (b), the road surface and roadblock information calculator 107 calculates a 7th distance DD_{U} 607 from the sensor 100 to the highest point HD_{U} 614 of roadblock 400 on the downslope surface based on DD_{U}=(S_{L}*T₇)/2, where S_{L} is the speed of the laser beam. A 8th distance DD_{D} 608 from the sensor 100 to the intersection point I of the flat surface 301 and the downslope surface 303 is calculated based on DD_{D}=(S_{L}*T₈)/2. The roadblock adjusted height RD_{AH} 613 at the upslope surface 303 can be calculated from equation (17)-(20).

$$\begin{matrix}{DD}_{H} = {\{ {DD}_{U}^{2} + {DD}_{D}^{2} - 2 \times {DD}_{U} \times {DD}_{D} \times cos ( {D}_{D} - {D}_{U} ) \}}^{0.5} & ( 17 ) \\ {α}_{5} = {sin}^{- 1} \{ \frac{{DD}_{U} \times sin ( {D}_{D} - {D}_{U} )}{{DD}_{H}} \} & ( 18 ) \\ {α}_{6} = ( {α}_{4} - {α}_{5} ) & ( 19 ) \\ {RD}_{AH} = {DD}_{H} \times sin ( {α}_{6} ) & ( 20 )\end{matrix}$$

Where DD_{H} 612 is the distance between the highest point HD_{U} 614 of roadblock 400 on the downslope surface 303 to the intersection point I of the flat surface 301 and the downslope surface 303, α₄ 602 is the angle ∠ JIS in FIG. 6 (a), α₅ 611 is the angle ∠ (HD_{U}) IS, α₆ 616 is the angle between the downslope surface and the intersection point I, and RD_{AH} 613 is the adjusted height of roadblock at the downslope surface 303.

At step 208, the roadblock sensing system 100 decides whether or not the vehicle can pass the roadblock. The decision processor 108 is a judgment means which determines whether or not the vehicle can pass the road based on roadblock's height H and roadblock's width W based on the information obtained from the step 204 to 207. H represents R_{H} at the flat surface, RU_{AH} at the upslope surface and RD_{AH} at the downslope surface. W represents R_{w} at the flat surface, RU_{w} at the upslope surface and RD_{w} at the downslope surface. The clearance height H_{C} and width W_{C} required in order that the vehicle 300 may pass through the roadblock 400 without contacting, are stored in the decision processor 108. The decision processor 108 determines whether the vehicle 300 passes through the roadblock target 400 safely without collision or contact, when the value of roadblock height value H is below the vehicle clearance height H_{C} and the value of roadblock width value W is below the vehicle clearance height W_{C}, In a case other than that, the decision processor 108 determines that the vehicle 300 cannot pass through the roadblock 400.

The impact reduction controller 109 sends out a warning signal when the decision processor 108 determines that the vehicle 300 passing through the roadblock 400 is not possible. While being a warning means which emits a warning to the driver and passengers of a vehicle, even if the vehicle 300 collides with the roadblock target 400, the damage caused by a collision is reduced.

The vehicle speed controller 110 controls the vehicle speed based on determination by the decision processor 108 shown in FIG. 1. For example, when it determines with the vehicle 300 carrying out the roadblock target 400, a collision, etc. in the decision processor 108, the impact reduction controller 109 directs the vehicle speed controller 110 decelerates the vehicle 300 by operating the brake of the vehicle 300 automatically.

The vehicle navigation controller 111 controls the vehicle route based on determination by the decision processor 108 shown in FIG. 1. For example, when decision processor 108 determines that the vehicle 300 cannot pass the roadblock 400 safely even with reduced speed safely, the decision processor 108, the vehicle navigation controller 111 reroute the vehicle 300 by providing another route for safety.

Next, a hardware description of the device according to exemplary embodiments is described with reference to FIG. 7. In FIG. 7, the device includes a CPU 700 which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The device in FIG. 7 also includes a network controller 706, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks. The network 77 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the device, such as Sound Blaster X-Fi Titanium from Creative, to interface with speakers/microphone 722 hereby providing sounds and/or music.

The general purpose storage controller 724 connects the storage medium disk 904 with communication bus 726, which may be an ISA, EISA, VESA, PCI, or similar, for interconnecting all of the components of the device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

It is to be understood that the present invention is not limited to the embodiments described above, but encompasses any and all embodiments within the scope of the following claims.

1. A roadblock sensor system comprising:
a transmitter configured to emit a laser light signal toward a roadblock and a road surface slope in a path of a vehicle;
a receiver configured to receive a reflection of the laser light signal reflected from the roadblock and the road surface; and
processing circuitry configured to
determine whether the road surface slope is a flat road surface, an upslope road surface or a downslope road surface,
calculate a height and a width of the roadblock based on a portion of the laser light signal reflected from the roadblock and the road surface slope as determined by the processing circuitry, and
determine whether the vehicle can safely clear the roadblock based on a comparison of a vehicle clearance height and the height and width of the roadblock calculated by the processing circuitry.

2. The roadblock sensor system of claim 1, wherein the processing circuitry includes:
a road surface slope detector configured to detect whether the road surface slope is the flat road surface, the upslope road surface or the downslope road surface;
a roadblock information detector configured to detect the roadblock at the road surface;
a vehicle speed controller configured to control a speed of the vehicle;
a vehicle navigation controller configured to control a route of the vehicle; and
an impact reduction controller configured to send a warning signal and direct the vehicle speed controller and the vehicle navigation controller to avoid a collision with the roadblock.

3. The system of claim 2, wherein the vehicle speed controller is configured to slow the vehicle by actuating a brake of said vehicle automatically to avoid hitting the roadblock.

4. The system of claim 2, wherein the vehicle navigator controller is configured to steer the vehicle around the roadblock when the decision processor determines the vehicle cannot safely pass over top of the roadblock.

5. The system of claim 2, wherein the roadblock information detector is further configured to calculate a value of the height of the roadblock for the flat road surface according to {D_{U}×sin(α_{U})+D_{D}×sin(α_{D})}
where DU is a first distance from the roadblock information detector to a first highest point of the roadblock at the flat road surface, DD is a second distance from the roadblock information detector to a lowest point of the roadblock at the flat surface, αU is a first angle between a vehicle central axis line and the laser light signal that scanned at the first highest point of the roadblock at the flat road surface, and αD is a second angle between the vehicle central axis line and the laser light signal scanned at the lowest point of the roadblock at the flat surface.

6. The system of claim 2, wherein the roadblock information detector is further configured to calculate a value of the height of the roadblock for the upslope road surface according to
{DU_{U}²+DU_{D}²−2×DU_{U}×DU_{D}×cos(U_{U}+U_{D})}^{0.5}×sin(α₃)
where DUU is a distance from the roadblock information detector to a second highest point of the roadblock at the upslope road surface, DUD is a distance from the roadblock information detector to a first intersection point of the upslope road surface and the flat surface, UU is an angle between the second highest point of the roadblock at the upslope road surface and a vehicle central axis line, UD is an angle between the vehicle central axis line and the first intersection point of the upslope road surface and the flat road surface, α₃ is an angle between the upslope road surface and a line formed by a second highest point of the roadblock at the upslope road surface and the first intersection point of the upslope road surface and the flat road surface.

7. The system of claim 2, wherein the roadblock information detector is further configured to calculate a value of the height of the roadblock for the downslope road surface according to
{DD_{U}²+DD_{D}²−2×DD_{U}×DD_{D}×cos(D_{D}−D_{U})}^{0.5}×sin(α₆)
wherein, DDU is a distance from the roadblock information detector to a third highest point of the roadblock at the downslope surface, DDD is a distance from the sensor to a second intersection point of between the downslope road surface and the flat road surface, DU is an angle between the third highest point of the roadblock at the downslope road surface and a vehicle central axis line, UD is an angle between the vehicle central axis line and the second intersection point of the downslope road surface and the flat road surface, α₆ is an angle between the downslope road surface and a line formed by the third highest point of the roadblock at the downslope road surface and the second intersection point of the downslope road surface and the flat road surface.

8. The system of claim 2, wherein the processing circuitry is configured to calculate the width of the roadblock according to
{D_{L}×sin(α_{L})+D_{R}×sin(α_{R})}
where DL is a distance from the roadblock information detector to a leftmost point of the roadblock at the road surface, DD is a distance from the roadblock information detector to a rightmost point of the roadblock at the road surface, αL is an angle between a vehicle central axis line and a location of where the laser light signal is scanned at a leftmost point of the roadblock at the road surface, αR is an angle between the vehicle central axis line and where the laser light signal is scanned at the rightmost point of the roadblock at the road surface.

9. A method for controlling a vehicle to avoid a collision with a detected roadblock, comprising:
transmitting a laser light signal from a vehicle-mounted transmitter toward the roadblock and a road surface;
receiving a reflection of the laser light signal reflected from the roadblock and the road surface, the road surface having one of a flat road surface, an upslope surface and a downslope surface in the path of the vehicle;
detecting with a road surface slope detector road surface information regarding a slope of the road;
determining with processing circuitry a slope orientation of the road surface;
calculating with processing circuitry a height and a width of the roadblock from the reflection of the laser light signal from the roadblock and the slope orientation of the road;
comparing with the processing circuitry a vehicle clearance height and the height and width of the roadblock to determine if the vehicle can safely clear the roadblock, and when it is determined that the vehicle cannot safely pass performing at least one of sending a warning signal through an impact reduction controller, reducing a speed of the vehicle speed a vehicle speed controller, and steering the vehicle around the roadblock with a vehicle navigation controller.

10. The method of claim 9, further comprising decelerating the vehicle by operating a brake of the vehicle to avoid a collision with the roadblock.

11. The method of claim 9, wherein the steering includes changing a driving direction of the vehicle to avoid hitting the roadblock.

12. The method of claim 9, wherein the calculating includes calculating the height of the roadblock for the flat road surface according to
{D_{U}×sin(α_{U})+D_{D}×sin(α_{D})}
where DU is a first distance from the roadblock information detector to a first highest point of the roadblock at the flat road surface, DD is a second distance from the roadblock information detector to a lowest point of the roadblock at the flat surface, αU is a first angle between a vehicle central axis line and the laser light signal that scanned at the first highest point of the roadblock at the flat road surface, and αD is a second angle between the vehicle central axis line and the laser light signal scanned at the lowest point of the roadblock at the flat surface.

13. The method of claim 9, wherein the calculating includes calculating the height of the roadblock for the upslope road surface according to
{DU_{U}²+DU_{D}²−2×DU_{U}×DU_{D}×cos(U_{U}+U_{D})}^{0.5}×sin(α₃)
where DUU is a distance from the roadblock information detector to a second highest point of the roadblock at the upslope road surface, DUD is a distance from the roadblock information detector to a first intersection point of the upslope road surface and the flat surface, UU is an angle between the second highest point of the roadblock at the upslope road surface and a vehicle central axis line, UD is an angle between the vehicle central axis line and the first intersection point of the upslope road surface and the flat road surface, α₃ is an angle between the upslope road surface and a line formed by a second highest point of the roadblock at the upslope road surface and the first intersection point of the upslope road surface and the flat road surface.

14. The method of claim 9, wherein the calculating includes
calculating the height of the roadblock for the downslope road surface according to
{DD_{U}²+DD_{D}²−2×DD_{U}×DD_{D}×cos(D_{D}−D_{U})}^{0.5}×sin(α₆)
where DDU is a distance from the roadblock information detector to a third highest point of the roadblock at the downslope surface, DDD is a distance from the sensor to a second intersection point of between the downslope road surface and the flat road surface, DU is an angle between the third highest point of the roadblock at the downslope road surface and a vehicle central axis line, UD is an angle between the vehicle central axis line and the second intersection point of the downslope road surface and the flat road surface, α₆ is an angle between the downslope road surface and a line formed by the third highest point of the roadblock at the downslope road surface and the second intersection point of the downslope road surface and the flat road surface.

15. The method of claim 9, wherein the calculating includes
calculating the width of the roadblock according to
{D_{L}×sin(α_{L})+D_{R}×sin(α_{R})}
where DL is a distance from the roadblock information detector to a leftmost point of the roadblock at the road surface, DD is a distance from the roadblock information detector to a rightmost point of the roadblock at the road surface, αL is an angle between a vehicle central axis line and a location of where the laser light signal is scanned at a leftmost point of the roadblock at the road surface, αR is an angle between the vehicle central axis line and where the laser light signal is scanned at the rightmost point of the roadblock at the road surface.

16. A non-transitory computer readable storage medium having stored therein instructions that when executed by processing circuitry cause the processing circuitry to perform a method for controlling a vehicle to avoid a collision with a detected roadblock, the method comprising:
transmitting a laser light signal from a vehicle-mounted transmitter toward the roadblock and a road surface;
receiving a reflection of the laser light signal reflected from the roadblock and the road surface, the road surface having one of a flat road surface, an upslope surface and a downslope surface in the path of the vehicle;
detecting with a road surface slope detector road surface information regarding a slope of the road;
determining with processing circuitry a slope orientation of the road surface;
calculating with processing circuitry a height and a width of the roadblock from the reflection of the laser light signal from the roadblock and the slope orientation of the road;
comparing with the processing circuitry a vehicle clearance height and the height and width of the roadblock to determine if the vehicle can safely clear the roadblock, and when it is determined that the vehicle cannot safely pass performing at least one of sending a warning signal through an impact reduction controller, reducing a speed of the vehicle speed a vehicle speed controller, and steering the vehicle around the roadblock with a vehicle navigation controller.

17. The computer readable storage medium of claim 16, wherein the method further comprising:
decelerating the vehicle by operating a brake of the vehicle to avoid a collision with the roadblock.

18. The computer readable storage medium of claim 16, wherein the steering includes changing a driving direction of the vehicle to avoid hitting the roadblock.

19. The computer readable storage medium of claim 16, wherein the calculating includes calculating the height of the roadblock for the flat road surface according to
{D_{U}×sin(α_{U})+D_{D}×sin(α_{D})}
where DU is a first distance from the roadblock information detector to a first highest point of the roadblock at the flat road surface, DD is a second distance from the roadblock information detector to a lowest point of the roadblock at the flat surface, αU is a first angle between a vehicle central axis line and the laser light signal that scanned at the first highest point of the roadblock at the flat road surface, and αD is a second angle between the vehicle central axis line and the laser light signal scanned at the lowest point of the roadblock at the flat surface.

20. The computer readable storage medium of claim 16, wherein the calculating includes calculating the height of the roadblock for the upslope road surface according to
{DU_{U}²+DU_{D}²−2×DU_{U}×DU_{D}×cos(U_{U}+U_{D})}^{0.5}×sin(α₃)
where DUU is a distance from the roadblock information detector to a second highest point of the roadblock at the upslope road surface, DUD is a distance from the roadblock information detector to a first intersection point of the upslope road surface and the flat surface, UU is an angle between the second highest point of the roadblock at the upslope road surface and a vehicle central axis line, UD is an angle between the vehicle central axis line and the first intersection point of the upslope road surface and the flat road surface, α₃ is an angle between the upslope road surface and a line formed by a second highest point of the roadblock at the upslope road surface and the first intersection point of the upslope road surface and the flat road surface.
